(19) United States
(12) Patent Application Publication
(10) Pub. No.: US 2022/0268068 A1
(43) Pub. Date: Aug. 25, 2022

(54) BOOTH

(71) Applicant: FUJIFILM BUSINESS INNOVATION CORP., Tokyo (JP)

(72) Inventors: Nobuhiro KITAGAWA, Kanagawa (JP); Shigenaga FUJIMURA, Kanagawa (JP); Kengo TOKUCHI, Kanagawa (JP)

(73) Assignee: FUJIFILM BUSINESS INNOVATION CORP., Tokyo (JP)

(21) Appl. No.: 17/372,953

(22) Filed: Jul. 12, 2021

(30) Foreign Application Priority Data
Feb. 24, 2021 (JP) 2021-027748

(51) Int. Cl. E05C 19/16; E05B 47/00

(52) U.S. Cl. CPC E05C 19/166; E05B 47/0002; E05Y 2201/462; E05Y 2900/132; E05Y 2201/218

(57) ABSTRACT

A booth includes: a booth body; a door that is openable and closable and that includes first and second end portions located at different positions in a widthwise direction of the door, a user-operable portion to be touched by a user to open and close the door being provided in the first end portion; and a door lock that is used for locking the door, the door being locked under control of current supply to the door lock. A portion of the door other than the first end portion is secured to the booth body by the door lock.

### CROSS-REFERENCE TO RELATED APPLICATIONS

This application is based on and claims priority under 35 USC 119 from Japanese Patent Application No. 2021-027748 filed Feb. 24, 2021.

### BACKGROUND

### (i) Technical Field

The present disclosure relates to a booth.

### (ii) Related Art

Japanese Unexamined Patent Application Publication No. 2015-209674 discloses a door lock control system installed in a building to verify the validity of an electronic key by using smart verification (ID verification using key-operation free system communication). An outdoor human detection sensor and an indoor human detection sensor are disposed on a door.

### SUMMARY

In a booth used by a user, a door and an electronic lock may be provided. The door may be locked by the electronic lock and part of the door may be secured to the booth body.

If a portion of the door to be secured to the booth body is located at a position that a user is likely to touch, a breakage or a fault may occur in this portion, and the door may not be locked.

Aspects of non-limiting embodiments of the present disclosure relate to a booth which makes it less likely for a user to touch a lock disposed on the booth than when a lock is disposed on a portion of a door of the booth that a user is likely to touch.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a booth including: a booth body; a door that is openable and closable and that includes first and second end portions located at different positions in a widthwise direction of the door, a user-operable portion to be touched by a user to open and close the door being provided in the first end portion; and a door lock that is used for locking the door, the door being locked under control of current supply to the door lock. A portion of the door other than the first end portion is secured to the booth body by the door lock.

### BRIEF DESCRIPTION OF THE DRAWINGS

An exemplary embodiment of the present disclosure will be described in detail based on the following figures, wherein:

FIG. 1 is a schematic diagram illustrating the overall configuration of an information processing system;

FIG. 2 illustrates a booth as an example of a space;

FIG. 3 illustrates the inside of the booth as viewed from above;

FIG. 4 is a perspective view of a door as viewed from the direction indicated by the arrow IV in FIG. 2;

FIG. 5 is a block diagram illustrating an example of the hardware configuration of a space management server;

FIG. 6 is a block diagram illustrating an example of the hardware configuration of a user terminal;

FIG. 7 is a block diagram illustrating an example of the hardware configuration of a control device disposed in the booth;

FIG. 8 illustrates an example of a display screen displayed on a user terminal when a user reserves a booth;

FIG. 9 illustrates another example of the display screen displayed on the user terminal;

FIGS. 10A and 10B are sectional views of the booth taken along line X-X in FIG. 2 and illustrates an example of the configuration of an electronic lock;

FIGS. 11A, 11B, and 11C illustrate a first end portion of the door and a booth body when the door is closed;

FIGS. 12A and 12B are enlarged views of a portion of a column storing an electromagnet therein;

FIGS. 13A and 13B illustrate a fixing member for fixing a magnetic attraction object to the door;

FIG. 14 is a sectional view of the booth taken along line XIV-XIV in FIG. 2;

FIG. 15 is a sectional view illustrating another example of the configuration of the electronic lock;

FIG. 16 illustrates an electrical wire for feeding power to the electromagnet;

FIG. 17 illustrates another example of the configuration of the booth;

FIG. 18 illustrates a comparative example of the booth;

FIG. 19 illustrates another example of the configuration of the booth;

FIG. 20 is a sectional view of the booth taken along line XX-XX in FIG. 19;

FIG. 21 illustrates another example of the configuration of the booth; and

FIGS. 22A through 23B are perspective views illustrating the structure of an electronic lock.

### DETAILED DESCRIPTION

An exemplary embodiment of the disclosure will be described below with reference to the accompanying drawings.

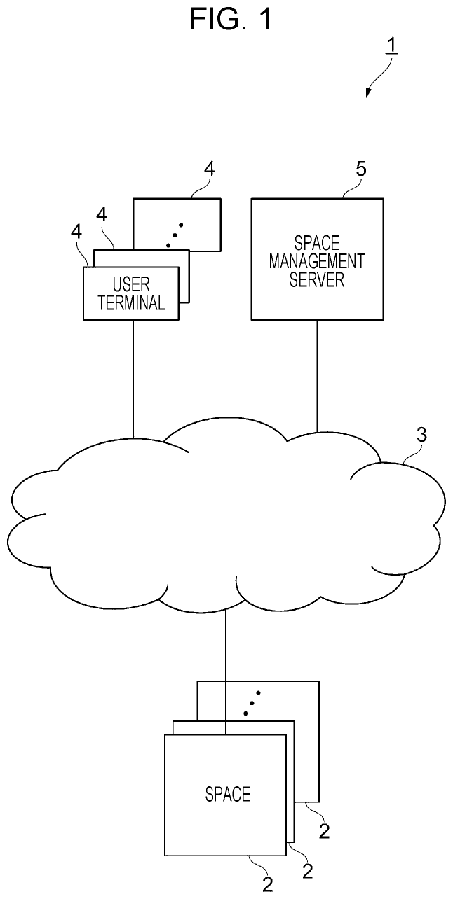

FIG. 1 is a schematic diagram illustrating the overall configuration of an information processing system 1 according to the exemplary embodiment.

In the exemplary embodiment, plural spaces 2, which are an example of a location to be reserved and used by a user, are provided. In the exemplary embodiment, a user first reserves a space 2 before the use.

One type of spaces 2 is closed spaces which are enclosed by walls or partitions. Examples of such spaces 2 are booths, rooms in accommodation facilities, and meeting rooms in companies.

Another type of spaces 2 is opened spaces. Examples of such spaces 2 are tables and seats in a restaurant and those at a barbershop at which a user receives a service.

The information processing system 1 shown in FIG. 1 includes various terminals connected to a cloud network 3.

In FIG. 1, as examples of terminals connected to the cloud network 3, user terminals 4 operated by users are shown, and a space management server 5, which is also as an example of an information processing apparatus that manages the spaces 2, is shown. The spaces 2 are connected to the cloud network 3. More specifically, various devices are disposed in the spaces 2 and such devices are connected to the cloud network 3.

In the exemplary embodiment, an electronic lock is attached to a door of each space 2, and each space 2 can be locked with this electronic lock. A user authorized to unlock a space 2 can use this space 2.

When unlocking a space 2, a user operates his/her user terminal 4 to give an instruction to unlock the space 2. This instruction is sent to the space management server 5. In response to this instruction, the space management server 5 instructs the space 2 to unlock it. This activates the electronic lock attached to the door of the space 2 to unlock the space 2.

In the exemplary embodiment, it is assumed that mobile terminals such as smartphones are used as the user terminals 4. Alternatively, wearable terminals, laptop computers, and game machines may be used as mobile user terminals 4.

The space management server 5 manages various types of information related to the spaces 2, such as information for identifying a user, information for identifying a space 2, and a reservation start time and end time.

Information for identifying a user may be the name, gender, age, account, user ID, password, and management information for this user. Information for identifying a space 2 may be information for identifying an address or a location of the space 2 and the management name and number of the space 2.

The space management server 5 also serves as a control device to control various devices installed in the spaces 2. The control device may alternatively be installed in each space 2 in association with each other. In this case, the control device disposed in each space 2 controls the various devices installed in the corresponding space 2.

### (External Configuration of Space 2)

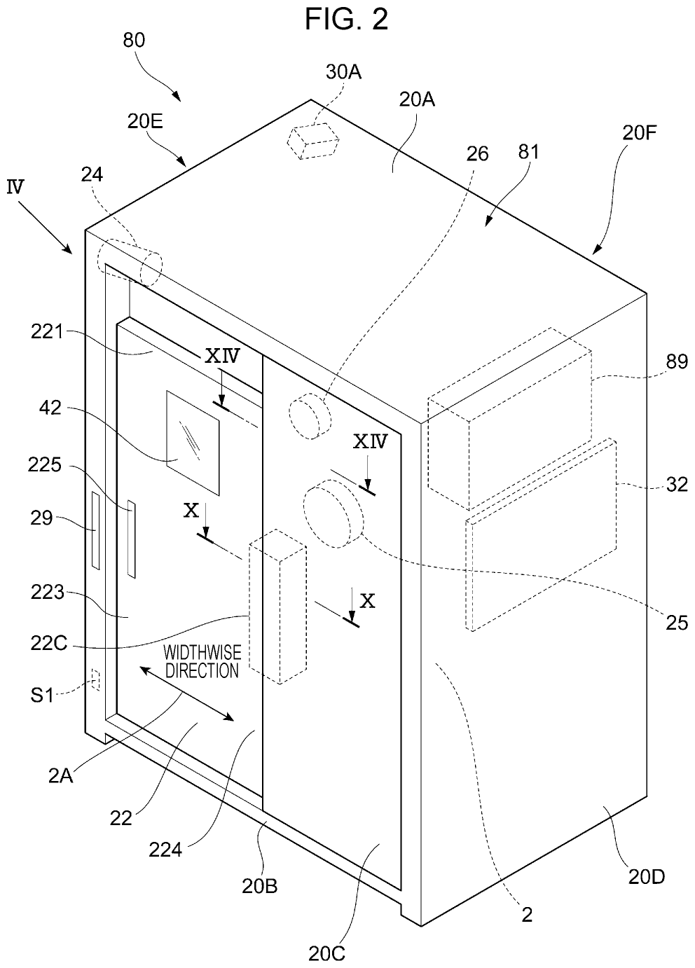

FIG. 2 illustrates a booth 80 as an example of a space 2.

In the example in FIG. 2, the inside of a booth 80 is a space 2 to be reserved. In other words, a user can reserve the inside of a booth 80 as a space 2.

Booths 80 are installed in various locations regardless of indoors and outdoors, such as in station buildings, airports, office buildings, commercial complexes (restaurants and department stores, for example), banks, libraries, art galleries, museums, public institutions, facilities, passageways, and parks.

The booth 80 shown in FIG. 2 is a closed booth 80 having a ceiling. However, “closed” does not mean “sealed”, and a closed booth may be any type of space having a practical soundproof function.

The booth 80 refers to a structure as a space 2 separated from another space with partitions. However, it is not necessary that the booth 80 be entirely surrounded by partitions. The booth 80 may be only partially provided with partitions. For example, only the left and right sides of a user inside the booth 80 may be closed with partitions. This structure is also an example of the booth 80.

The ceiling may not be necessary, and a booth 80 without a ceiling is also an example of a space 2.

In the booth 80 shown in FIG. 2, a booth body 81, which forms the major part of the booth 80, is disposed. The booth body 81 has a cuboidal shape.

The booth body 81 is constituted by a ceiling 20A, a floor 20B, a side wall 20C, two side walls 20D and 20E at both sides of the booth body 81, and a side wall 20F opposite the side wall 20C.

In the exemplary embodiment, the side wall 20C is located at the near side of the booth body 81, while the side wall 20F is located at the far side of the booth body 81. The side walls 20C and 20F are disposed to oppose each other.

The two side walls 20D and 20E are disposed perpendicularly with the side walls 20C and 20F. The side walls 20D and 20E are disposed to oppose each other.

In the exemplary embodiment, a door 22 which can be opened and closed is installed at the near side of the booth 80. The door 22 is movable along the side wall 20C in the direction indicated by the double-headed arrow 2A in FIG. 2.

The door 22 is a hung-type door. In the exemplary embodiment, a guide rail (not shown) is provided to extend along the moving direction of the door 22 and to support a top end portion 221 of the door 22. The door 22 moves along this guide rail.

In the exemplary embodiment, the space 2 is surrounded by the side walls 20C, 20D, 20E, and 20F and the door 22 and is disposed inside of these four side walls and the door 22. To put it another way, the space 2 is disposed inside the booth body 81.

In the exemplary embodiment, the door 22 is assumed to be a sliding door that can move along the side wall 20C, namely, a sliding door movable in the direction indicated by the double-headed arrow 2A in FIG. 2. The direction indicated by the double-headed arrow 2A is the widthwise direction of the door 22, and the door 22 moves along the widthwise direction.

In FIG. 2, the door 22 is a single sliding door in which one door member slides. The door 22 may alternatively be a sliding door in which two or more door members slide in opposite directions on different rails or a sliding door in which one door member slides to the left and the other door member slides to the right. The door 22 may be a hinged door, which may be an inward opening type or an outward opening type.

As shown in FIG. 2, the door 22 has one end portion 223 (which will be called a first end portion 223) and the other end portion 224 (which will be called a second end portion 224) that are located at different positions in the widthwise direction. The door 22 also includes a user-operable portion 225 to be touched by a user to open and close the door 22. The user-operable portion 225 is provided in the first end portion 223 of the door 22.

Specifically, the user-operable portion 225 is a handle. To open or close the door 22, a user holds the user-operable portion 225. The user-operable portion 225 is not limited to the form shown in FIG. 2 and may have another form, such as a door knob. Another user-operable portion 225 is also provided on the door 22 inside the booth body 81.

In the booth 80, a door box, which serves as a storage for the door 22, is disposed behind the side wall 20C. When a user opens the door 22, the door 22 moves inside this door box starting from the second end portion 224 as the leading end. Details of the door box will be discussed later.

An electronic lock 22C is provided as an example of a door lock. In the exemplary embodiment, a door state sensor S1 is disposed to detect the opening and closing of the door 22.

The door 22 is locked and unlocked by the electronic lock 22C. More specifically, current supply to the electronic lock 22C is controlled so as to lock or unlock the door 22. That is, the electronic lock 22C is a key to lock and unlock the door 22 under the control of current supply to the electronic lock 22C.

The electronic lock 22C may lock and unlock the door 22 by using a battery or by using power supplied from an external power source.

The electronic lock 22C may lock and unlock the door 22 in any mode. For example, in one mode, a current is supplied to an electromagnet disposed in the electronic lock 22C to generate magnetic force, thereby locking the door 22, and current supply to the electromagnet is stopped to unlock the door 22. In another mode, to lock the door 22, a movable member of the electronic lock 22C is moved (activated) by a motor or a solenoid so as to be hooked on a hooking portion provided on or close to the door 22 or the booth body 81. To unlock the door 22, the movable member is moved to separate from this hooking portion.

The number of users using the booth 80 is largely determined by the volume of the booth 80. In the exemplary embodiment, a private space basically for one person is assumed as the booth 80. A private space is not necessarily for only one person and may accommodate a small group of people, such as two or three people. The booth 80 may alternatively be a large booth for accommodating a large group of people.

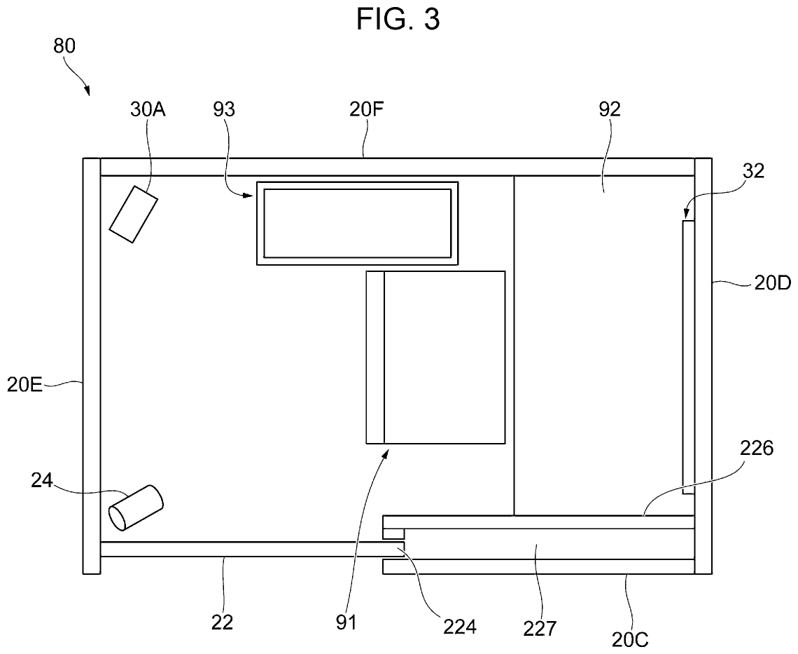

FIG. 3 illustrates the inside of the booth 80 as viewed from above.

In the example in FIG. 3, one desk 92 and one chair 91 are placed inside the booth 80.

A container 93 for a user to put his/her personal belongings is also provided inside the booth 80.

As a device installed inside the booth 80, an internal monitor 32, which is a display for displaying information, is disposed, as shown in FIGS. 2 and 3.

An internal speaker 30A which outputs sound is also disposed, as shown in FIGS. 2 and 3. Instead of the internal speaker 30A, a speaker installed in the internal monitor 32 may be used.

An internal imager 24 that takes an image of the inside of the booth 80 is also provided, as shown in FIGS. 2 and 3. The internal imager 24 includes imaging elements, such as charge-coupled devices (CCDs) or complementary metal-oxide-semiconductors (CMOSs), and takes an image of the inside of the booth 80 by using the imaging elements.

As shown in FIG. 2, a human sensor 25 is also provided on the booth 80 to detect a user inside the booth 80, and a temperature sensor 26 is also provided to detect the temperature inside the booth 80. Lighting equipment (not shown) for illuminating the inside of the booth 80 is also fixed in the booth 80.

As shown in FIG. 2, a window 42 is provided on the door 22. In the exemplary embodiment, the inside of the space 2 can be seen through the window 42 from the outside.

As shown in FIG. 2, an information obtaining device 29 for obtaining personal information about a user using the booth 80 may be disposed on the outer surface of the booth 80.

The information obtaining device 29 may be a reader for reading an identification (ID) card passing over the reader. The information obtaining device 29 may be a reader for reading biological information, such as user's fingerprints or finger vein patterns.

An air-conditioning device is also disposed in the booth 80 to adjust the temperature inside the booth 80, though it is not shown.

As shown in FIG. 2, a control device 89 is disposed in the booth 80 to control the individual units of the booth 80.

As shown in FIG. 3, an inner wall 226 made of a plank is provided inside the booth 80 at a position opposing the side wall 20C. In the exemplary embodiment, a door box 227 for storing the door 22 is disposed between the inner wall 226 and the side wall 20C.

When a user opens the door 22, the door 22 moves inside the door box 227 starting from the second end portion 224 as the leading end and is stored in the door box 227.

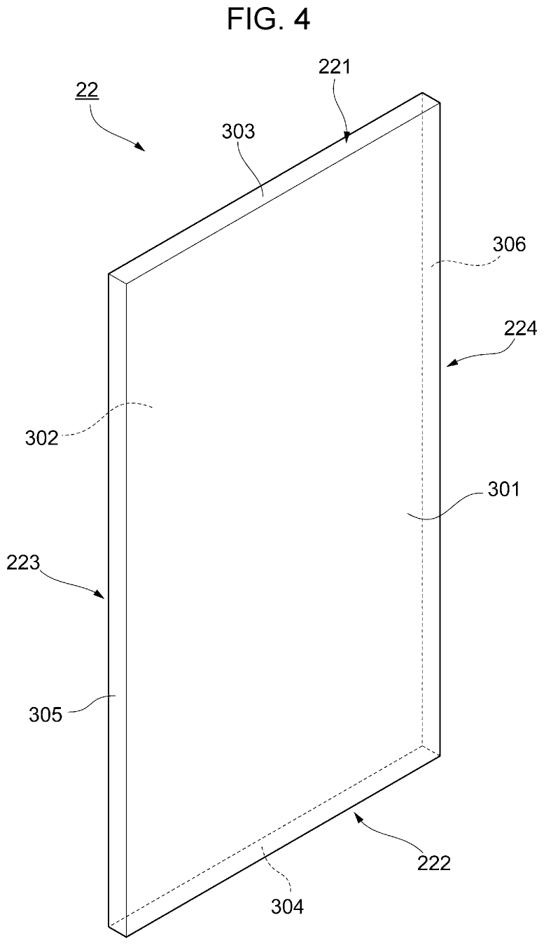

FIG. 4 is a perspective view of the door 22 as viewed from the direction indicated by the arrow IV in FIG. 2. In FIG. 4, some elements, such as the window 42 (see FIG. 2), are not shown.

The door 22 has a rectangular shape as viewed from the front side of the booth 80.

The door 22 has a shape of a rectangular prism with six rectangular faces. More specifically, the door 22 has an outer face 301 facing the exterior of the booth 80 and an inner face 302 facing the interior of the booth 80. The outer face 301 and the inner face 302 oppose each other. The door 22 also has a top face 303 positioned at the top end portion 221 of the door 22 and a bottom face 304 positioned at a bottom end portion 222 of the door 22. The door 22 also has a left face 305 positioned at the first end portion 223 of the door 22 and a right face 306 positioned at the second end portion 224 of the door 22.

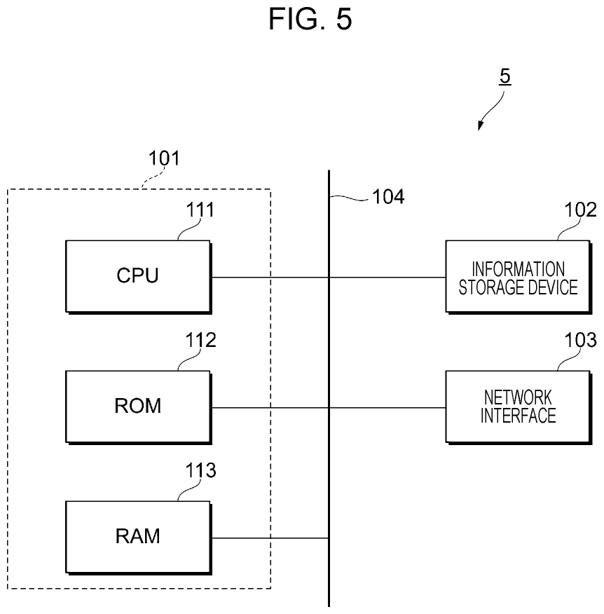

FIG. 5 is a block diagram illustrating an example of the hardware configuration of the space management server 5.

The space management server 5, which is an example of the information processing apparatus, includes a control unit 101 that controls the operation of the entire space management server 5, an information storage device 102 storing information, such as management data, and a network interface 103 that performs communication via a local area network (LAN) cable, for example.

The control unit 101 includes a central processing unit (CPU) 111, which is an example of a processor, a read only memory (ROM) 112 storing basic software and basic input output system (BIOS), and a random access memory (RAM) 113 used as a work area.

The CPU 111 may be a multi-core processor. The ROM 112 may be a rewritable non-volatile semiconductor memory. The control unit 101 is a computer.

The information storage device 102 is constituted by a hard disk drive, for example. More specifically, the information storage device 102 is a device that reads and writes data from and into a non-volatile storage medium coated with a magnetic material on the surface of a disc-shaped substrate. The information storage device 102 may be a semiconductor memory or magnetic tape.

The space management server 5 also includes an input device, such as a keyboard and a mouse, and a display device, such as a liquid crystal display, as required.

The control unit 101, the information storage device 102, and the network interface 103 are connected to each other via a bus 104 and a signal line, which is not shown.

A program to be executed by the CPU 111 may be stored in a computer-readable recording medium, such as a magnetic recording medium (magnetic tape and a magnetic disk, for example), an optical recording medium (an optical disc, for example), a magneto-optical recording medium, and a semiconductor memory, and then be provided to the space management server 5.

A program to be executed by the CPU 111 may be provided to the space management server 5 by using a communication medium, such as the internet.

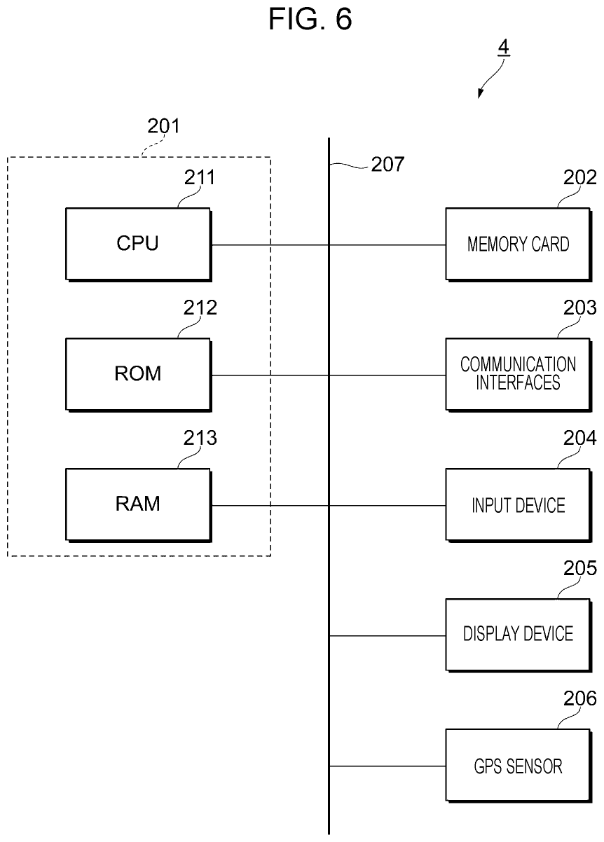

FIG. 6 is a block diagram illustrating an example of the hardware configuration of a user terminal 4. The hardware configuration in FIG. 6 is a configuration when the user terminal 4 is a smartphone.

The user terminal 4 includes a control unit 201 that controls the operation of the entire user terminal 4, a memory card 202 storing various types of data, various communication interfaces 203 compliant with wireless communication standards, an input device 204, such as a touch sensor, a display device 205, such as a liquid crystal display or an organic electroluminescence (EL) display, and a global positioning system (GPS) sensor 206.

The control unit 201 includes a CPU 211, a ROM 212 storing firmware and BIOS, for example, and a RAM 213 used as a work area. The CPU 211 may be a multi-core processor. The ROM 212 may be a rewritable non-volatile semiconductor memory.

The communication interfaces 203 include an interface for connecting to a mobile communication system and an interface for connecting to a wireless LAN.

The GPS sensor 206 is a sensor that locates the user terminal 4 by receiving radio waves from GPS satellites. Information about the latitude, longitude, and altitude output from the GPS sensor 206 determines the current position of the user terminal 4. The GPS sensor 206 may cover the function of an indoor positioning system.

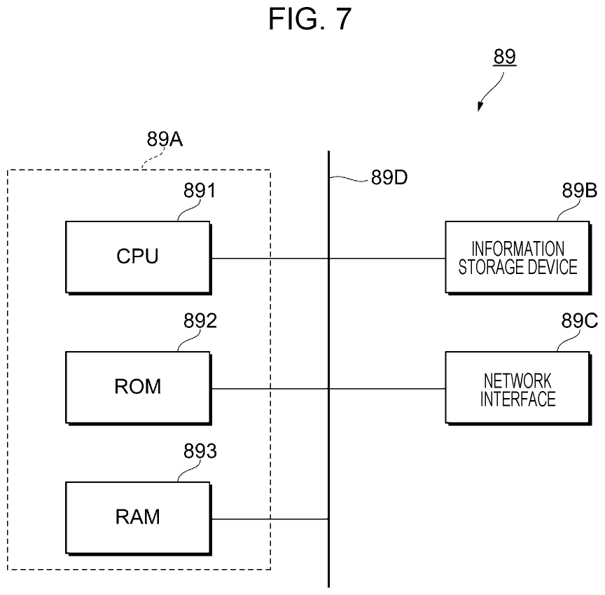

FIG. 7 is a block diagram illustrating an example of the hardware configuration of the control device 89 (see FIG. 2) disposed in the booth 80.

The control device 89 includes an information processor 89A, an information storage device 89B storing information, and a network interface 89C that performs communication via a LAN cable, for example.

The information processor 89A includes a CPU 891, which is an example of a processor, a ROM 892 storing basic software and BIOS, and a RAM 893 used as a work area.

The CPU 891 may be a multi-core processor. The ROM 892 may be a rewritable non-volatile semiconductor memory. The information processor 89A is a computer.

The information storage device 89B is constituted by a hard disk drive, for example. The information storage device 89B may be a semiconductor memory or magnetic tape.

The information processor 89A, the information storage device 89B, and the network interface 89C are connected to each other via a bus 89D and a signal line, which is not shown.

A program to be executed by the CPU 891 may be stored in a computer-readable recording medium, such as a magnetic recording medium (magnetic tape and a magnetic disk, for example), an optical recording medium (an optical disc, for example), a magneto-optical recording medium, and a semiconductor memory, and then be provided to the control device 89.

A program to be executed by the CPU 891 may be provided to the control device 89 by using a communication medium, such as the internet.

In the embodiment, the term “processor” refers to hardware in a broad sense. Examples of the processor include general processors (e.g., CPU) and dedicated processors (e.g., GPU: Graphics Processing Unit, ASIC: Application Specific Integrated Circuit, FPGA: Field Programmable Gate Array, and programmable logic device).

In the embodiment, the term “processor” is broad enough to encompass one processor or plural processors in collaboration which are located physically apart from each other but may work cooperatively. The order of operations of the processor is not limited to one described in the embodiment, and may be changed.

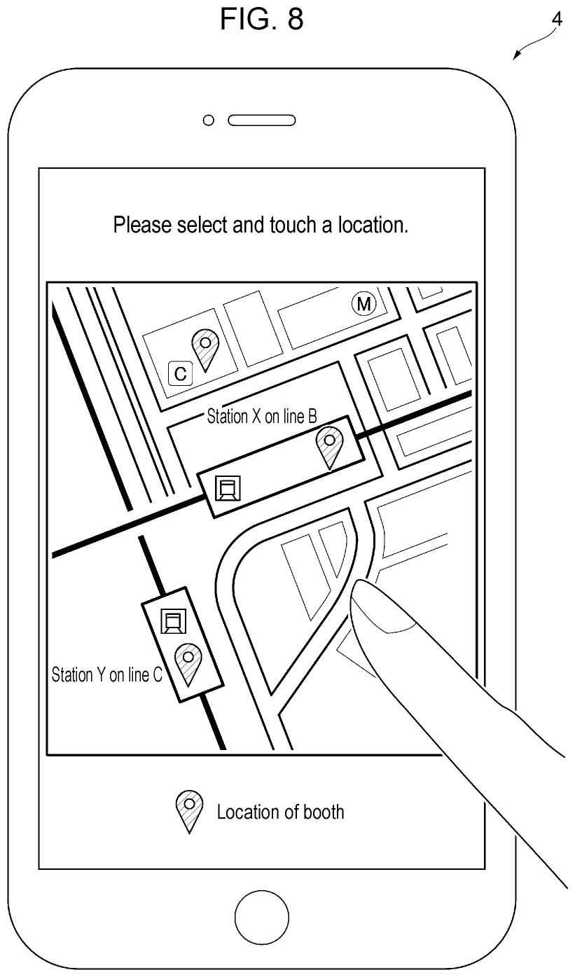

FIG. 8 illustrates an example of a display screen displayed on a user terminal 4 when a user reserves a booth 80.

On the display screen in FIG. 8, a map is shown, and multiple locations where booths 80 are installed are displayed on this map.

When reserving a booth 80, the user is instructed to choose a location from the multiple locations on the map.

Instead of the display mode shown in FIG. 8, multiple locations of booths may be displayed in a list, and the user may select a location from the list.

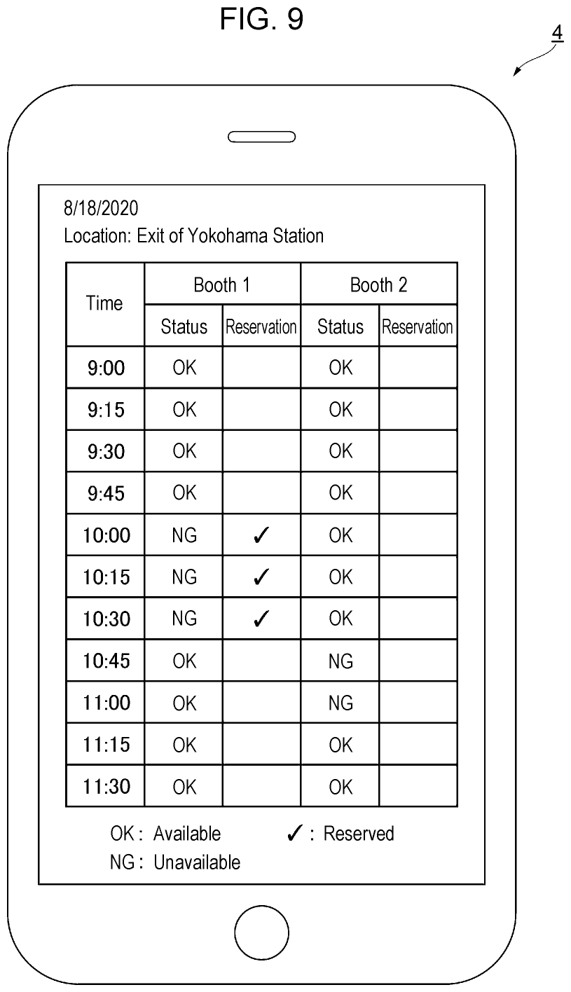

When the user has selected a location, the availability status at the selected location per unit time, such as per 15 minutes, is displayed on the user terminal 4, as shown in FIG. 9. In the example in FIG. 9, two booths 80 are installed at the selected location.

The user operates the display screen and specifies a reservation time for the selected booth 80 and presses a setting button (not shown).

The space management server 5 executes reservation fixing processing.

More specifically, the space management server 5 executes reservation fixing processing by receiving information about the location and the reservation time of the booth 80 and registering this information in the information storage device 102 (see FIG. 5). The result is then sent to the user terminal 4 to inform the user that the reservation is fixed.

When the reservation made by the user has been completed, information indicating the completion of the reservation is displayed on the user terminal 4.

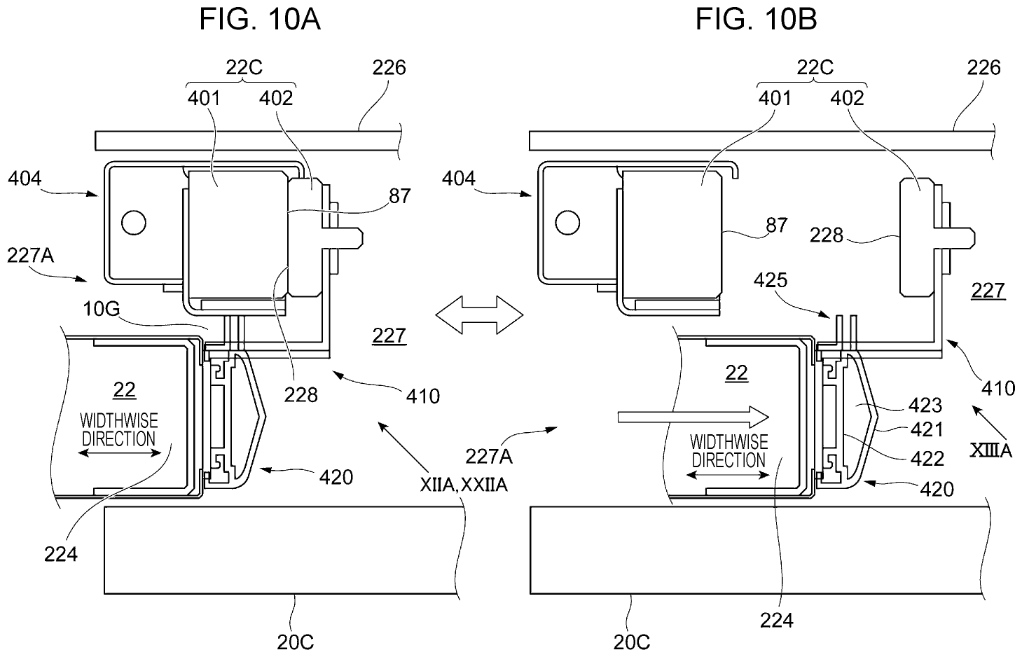

FIGS. 10A and 10B are sectional views of the booth 80 taken along line X-X in FIG. 2.

The electronic lock 22C will be explained below with reference to FIGS. 10A and 10B. FIG. 10A illustrates a state in which the door 22 is closed, while FIG. 10B illustrates a state in which the door 22 is open.

In the exemplary embodiment, the electronic lock 22C is disposed in the state shown in FIG. 10A. The electronic lock 22C includes an electromagnet 401 and a magnetic attraction object 402 to be attracted to the electromagnet 401. The magnetic attraction object 402 is made of a ferromagnetic material, such as iron.

The electromagnet 401 is disposed near the booth body (see FIG. 2), while the magnetic attraction object 402 is disposed near the door 22.

Conversely, the electromagnet 401 may be located near the door 22, while the magnetic attraction object 402 may be located near the booth body 81.

As shown in FIGS. 10A and 10B, a column 404 extending in the vertical direction is installed on the booth body 81. In the exemplary embodiment, the electromagnet 401 is stored inside the column 404.

The electromagnet 401 may be entirely stored in the column 404 or may be only partially stored in the column 404 and partially project from the column 404.

As shown in FIG. 10B, the magnetic attraction object 402 is provided near the door 22 and moves together with the door 22. A fixing member 410 is provided on the door 22 to fix the magnetic attraction object 402 to the door 22.

As shown in FIG. 10B, an elastic member 420 is provided in the second end portion 224 of the door 22 to ease a shock acting on the door 22 and the booth body 81.

When the door 22 is wide open, the second end portion 224 of the door 22 may strike the side wall 20D (see FIG. 2).

The elastic member 420 is located between the door 22 and the side wall 20D so as to ease a shock acting on the side wall 20D and that on the door 22 when the door 22 is hit against the side wall 20D.

The elastic member 420 is made of rubber, for example. The elastic member 420 includes a wall-side part 421 located close to the side wall 20D and a door-side part 422 located close to the door 22. In the exemplary embodiment, a space 423 is formed between the wall-side part 421 and the door-side part 422.

When the elastic member 420 is brought into contact with the side wall 20D, the wall-side part 421 is elastically deformed to approach the door-side part 422, thereby easing the above-described shocks.

As shown in FIG. 10B, a gap filling member 425 is provided to fill a gap 10G (see FIG. 10A) formed between the door 22 and the column 404.

The gap filling member 425 is formed integrally with the elastic member 420. Alternatively, the gap filling member 425 may be provided separately from the elastic member 420.

An urging mechanism (not shown) for urging the door 22 to the side wall 20E (see FIG. 2) is provided to automatically close the door 22.

In the exemplary embodiment, the inner wall 226 is located at a position opposing the side wall 20C, as shown in FIGS. 10A and 10B. A space is formed between the side wall 20C and the inner wall 226 so as to serve as the door box 227 which stores the door 22.

The column 404 extending in the vertical direction is installed inside the door box 227, more specifically, in an entrance portion 227A of the door box 227. The electromagnet 401 is disposed inside the column 404 and is thus located inside the door box 227, more specifically, in the entrance portion 227A of the door box 227.

The magnetic attraction object 402 is also disposed inside the door box 227. That is, the electronic lock 22C is located inside the door box 227.

As shown in FIGS. 10A and 10B, the fixing member 410 and the elastic member 420 are also disposed inside the door box 227.

In the state in FIG. 10A, when a current is supplied to the electromagnet 401, the magnetic attraction object 402 is attracted to and attached to the electromagnet 401. In this manner, the door 22 is secured to the booth body 81 so that it is not opened.

This will be described more specifically. The magnetic attraction object 402, which forms part of the electronic lock 22C, is provided near the second end portion 224 of the door 22. In response to current supply to the electromagnet 401, the second end portion 224 of the door 22 is secured to the booth body 81 by the electronic lock 22C.

As shown in FIG. 10B, a door-side intersecting surface 228, which extends in a direction intersecting (perpendicular) with the widthwise direction of the door 22, is disposed near the door 22. Likewise, a booth-side intersecting surface 87, which extends in a direction intersecting (perpendicular) with the widthwise direction of the door 22, is disposed near the booth body 81.

The door-side intersecting surface 228 is constituted by a side surface of the magnetic attraction object 402, while the booth-side intersecting surface 87 is constituted by a side surface of the electromagnet 401.

In the exemplary embodiment, when the door 22 is closed, as shown in FIG. 10A, the door-side intersecting surface 228 and the booth-side intersecting surface 87 face each other.

By the provision of the electronic lock 22C, the door-side intersecting surface 228 is attracted to the booth-side intersecting surface 87, thereby locking the door 22.

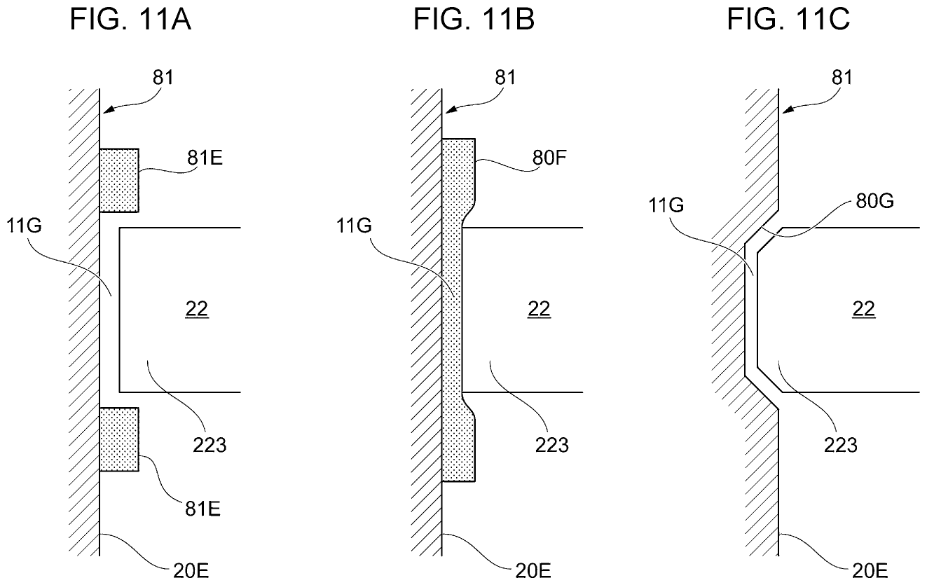

FIGS. 11A through 11C illustrate the first end portion 223 of the door 22 and the booth body 81 when the door 22 is closed.

In the state in which the electromagnet 401 and the magnetic attraction object 402 contact each other (see FIG. 10A), a gap 11G is formed between the first end portion 223 of the door 22 and the side wall 20E of the booth body 81, as shown in FIG. 11A.

With this configuration, when the door 22 is closed, it is securely locked by preventing the electromagnet 401 and the magnetic attraction object 402 from separating from each other.

With the gap 11G, however, a user may be misled into thinking that the door 22 is not closed properly and try to force the door 22 closed. To avoid such a situation, projections 81E are provided to make the gap 11G unseen from the inner and outer sides of the door 22, as shown in FIG. 11A.

Instead of the configuration in FIG. 11A, an elastic body 80F may be provided between the first end portion 223 of the door 22 and the side wall 20E so as to fill the gap 11G, as shown in FIG. 11B. Alternatively, a recessed portion 80G may be formed in the side wall 20E to receive the first end portion 223 of the door 22 and to make the gap 11G unseen, as shown in FIG. 11C.

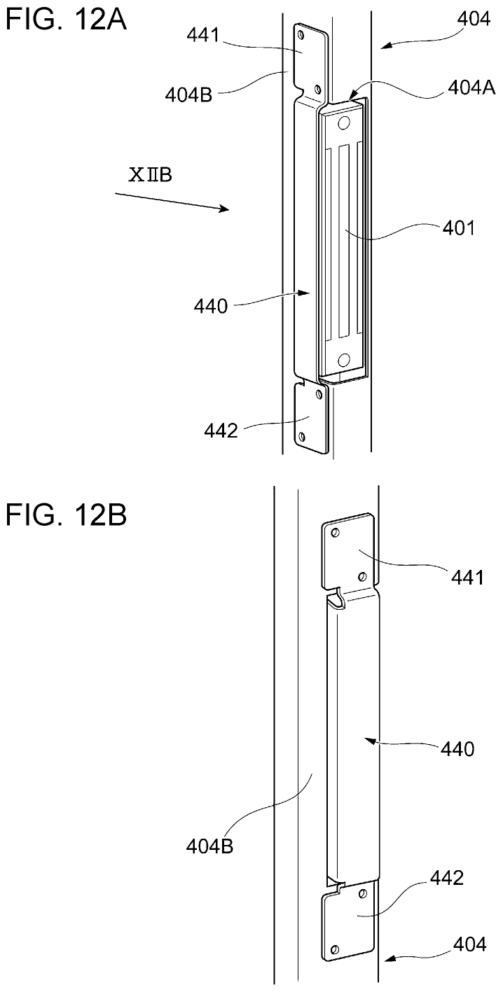

FIGS. 12A and 12B are enlarged views of the portion of the column 404 which stores the electromagnet 401 therein. More specifically, FIG. 12A illustrates the column 404 as viewed from the direction indicated by the arrow XIIA in FIG. 10A. FIG. 12B illustrates the column 404 as viewed from the direction indicated by the arrow XIIB in FIG. 12A.

As shown in FIG. 12A, a notch 404A is formed in part of the column 404, and the electromagnet 401 is stored in the notch 404A of the column 404. As shown in FIGS. 12A and 12B, a constraining member 440 is provided on the column 404 so as to constrain the movement of the electromagnet 401 in relation to the column 404.

The constraining member 440 is attached to a surface 404B of the column 404 facing the side wall 20C (see FIG. 10A) so as to constrain the electromagnet 401 from moving toward the side wall 20C.

The constraining member 440 is formed in a planar shape along the vertical direction, which is the extending direction of the column 404.

A top end portion 441 and a bottom end portion 442 of the constraining member 440 are fastened to the column 404 by fastening members, such as screws.

The electromagnet 401 is located at a position opposing the intermediate portion of the constraining member 440 between the top end portion 441 and the bottom end portion 442. The movement of the electromagnet 401 is constrained by this intermediate portion of the constraining member 440.

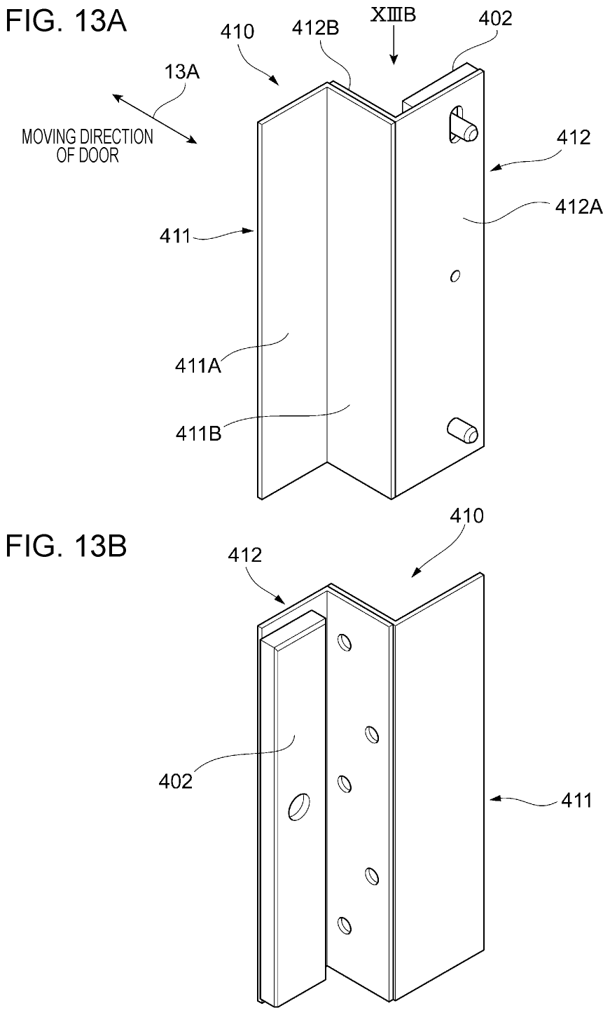

FIGS. 13A and 13B illustrate the fixing member 410 for fixing the magnetic attraction object 402 to the door 22. FIG. 13A illustrates the fixing member 410 as viewed from the direction indicated by the arrow XIIIA in FIG. 10B. FIG. 13B illustrates the fixing member 410 as viewed from the direction indicated by the arrow XIIIB in FIG. 13A.

As shown in FIG. 13A, the fixing member 410 includes a door-fastened member 411 to be fastened to the door 22 and a support member 412 which supports the magnetic attraction object 402. The door-fastened member 411 and the support member 412 are each formed in an L shape in horizontal cross section.

The door-fastened member 411 has first and second parts 411A and 411B. The first part 411A is disposed in a direction perpendicular to the moving direction of the door 22 and is fixed to the right face 306 (see FIG. 4) of the door 22. The second part 411B extends toward the side wall 20D (see FIG. 2) starting from a portion connected to the first part 411A.

The support member 412 has first and second parts 412A and 412B. The first part 412A is disposed in a direction perpendicular to the moving direction of the door 22, and the magnetic attraction object 402 is fastened to the first part 412A. The second part 412B extends toward the side wall 20E (see FIG. 2) starting from a portion connected to the first part 412A.

The magnetic attraction object 402 is fastened to the first part 412A of the support member 412 by fastening members, such as screws.

The second part 411B of the door-fastened member 411 and the second part 412B of the support member 412 face each other.

The support member 412 is movable in the direction indicated by the double-headed arrow 13A in FIG. 13A, which is the moving direction of the door 22.

In the exemplary embodiment, at the time of shipping of the booth 80, after the position of the support member 412 in relation to the door-fastened member 411 fastened to the door 22 is adjusted, the support member 412 is fixed to the door-fastened member 411. In other words, after the position of the magnetic attraction object 402 in relation to the door 22 is adjusted, the magnetic attraction object 402 is fixed to the door 22.

In the exemplary embodiment, the position of the magnetic attraction object 402 to the door 22, that is, the position of the magnetic attraction object 402 in the widthwise direction of the door 22, is adjustable. After this adjustment is conducted, the support member 412 is fixed to the door-fastened member 411.

More specifically, at the time of shipping of the booth 80, in the state in which the door 22 is closed (the state in FIG. 11A), the position of the support member 412 to the door-fastened member 411 is adjusted so that the electromagnet 401 and the magnetic attraction object 402 contact each other.

This makes it possible to avoid the following inconveniences, for example: the door 22 is not locked because of a gap formed between the electromagnet 401 and the magnetic attraction object 402 when the door 22 is closed; and the magnetic attraction object 402 strikes the electromagnet 401 so as to constrain the movement of the door 22 and fails to close the door 22.

After the adjustment of the position of the support member 412 to the door-fastened member 411 has finished, the door-fastened member 411 and the support member 412 are fixed with each other by a fastening member, such as a nut and a bolt, or by welding.

If a fastening member is used, an elongated hole is formed in one of the door-fastened member 411 and the support member 412 so that one of them can move against the other one. This can adjust the position of the support member 412 to the door-fastened member 411, as described above.

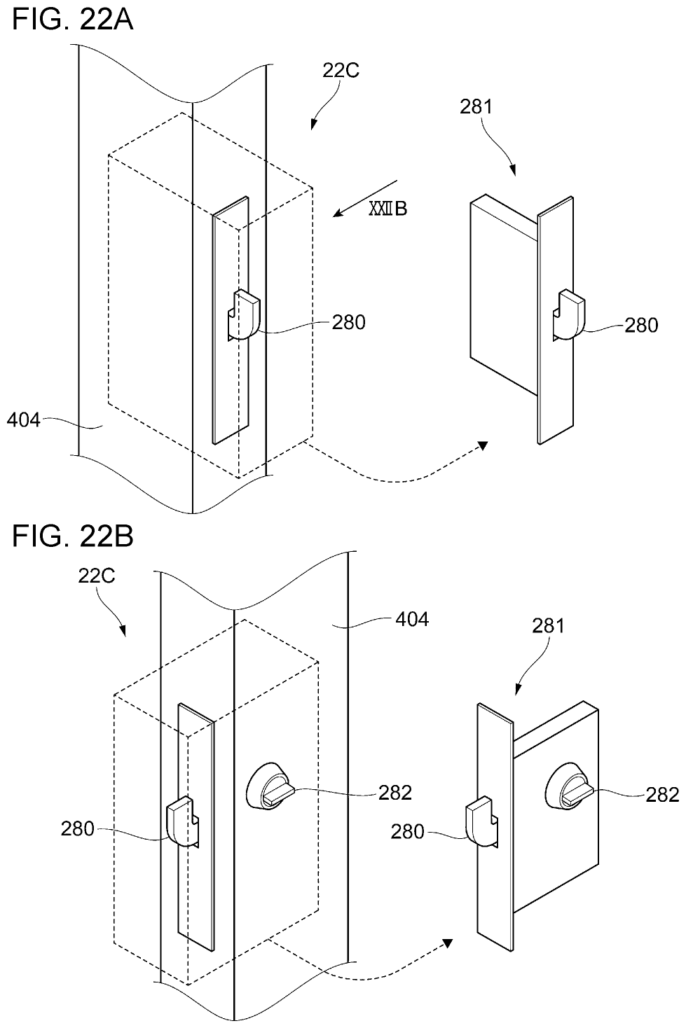

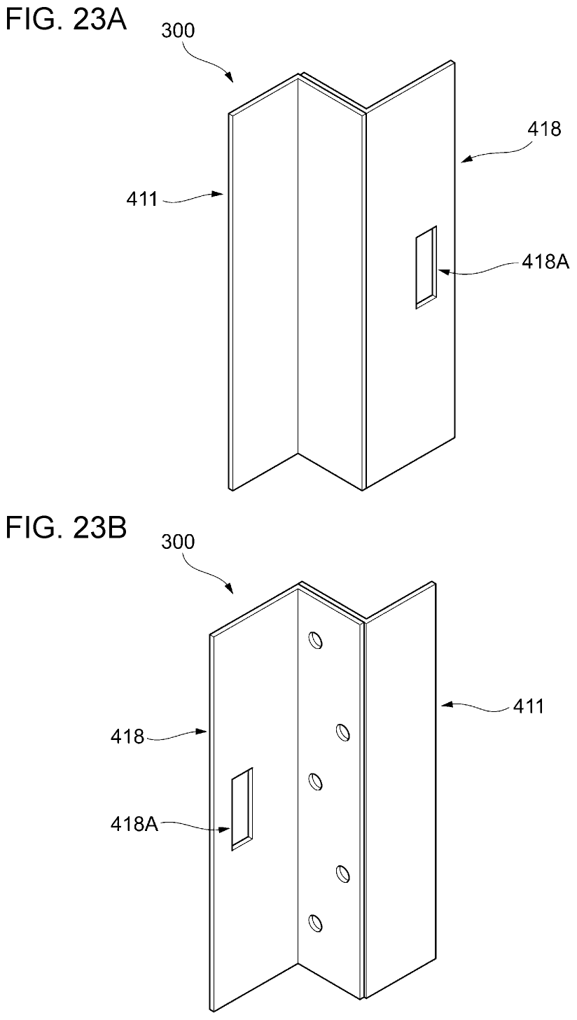

The electronic lock 22C may be formed, as shown in FIGS. 22A through 23B. FIG. 22A is a perspective view of the electronic lock 22C when the column 404 is seen from the direction indicated by the arrow XXIIA in FIG. 10A. FIG. 22B is a perspective view of the electronic lock 22C when the column 404 is seen from the direction indicated by the arrow XXIIB in FIG. 22A.

In this configuration example in FIGS. 22A and 22B, an electric hook lock 281 is provided inside the column 404, as shown in FIG. 22A. Under the control of current supply to the electric hook lock 281, a movable member 280 having the shape of a sickle protrudes while turning.

A thumb turn 282 is provided in the electric hook lock 281, as shown in FIG. 22B, which enables a user inside the booth 80 to manually lock and unlock the door 22.

On the side of the door 22, an interlocking member 300 is provided to move together with the door 22, as shown in FIGS. 23A and 23B.

The interlocking member 300 is configured similarly to the above-described fixing member 410 (see FIGS. 13A and 13B). The interlocking member 300 includes a door-fastened member 411 to be fastened to the door 22 and a hooking member 418 on which the movable member 280 (see FIG. 22A) is hooked. In the hooking member 418, a through-hole 418A is formed to receive the movable member 280.

In the configuration example shown in FIGS. 22A through 23B, to lock the door 22, a current is supplied to the electric hook lock 281 to activate a motor or a solenoid, which makes the movable member 280 protrude. The movable member 280 protrudes and is inserted into the through-hole 418A in the interlocking member 300.

In this state, even if a user tries to open the door 22, the movable member 280 is hooked on the hooking member 418, which is an example of a hooking portion, to prevent the door 22 from opening. In other words, the movable member 280 is positioned on a movement path of the interlocking member 300, which moves together with the door 22, thereby preventing the door 22 from opening.

When current supply to the electric hook lock 281 is stopped, the movable member 280 retreats and separates from the through-hole 418A, which makes it possible to open the door 22.

In the configuration example in FIGS. 22A through 23B, as well as in the configuration of the fixing member 410 shown in FIG. 13A, the position of the hooking member 418 to the door 22, that is, the position of the hooking member 418 in the widthwise direction of the door 22, is adjustable. After this adjustment is conducted, the hooking member 418 is fixed to the door-fastened member 411.

More specifically, at the time of shipping of the booth 80, in the state in which the door 22 is closed (the state in FIG. 11A), the position of the hooking member 418 to the door-fastened member 411 is adjusted so that the movable member 280 can be inserted into the through-hole 418A.

This makes it possible to avoid the following inconveniences, for example: the door 22 is not locked because of a gap formed between the movable member 280 and the hooking member 418 when the door 22 is closed; and the hooking member 418 strikes the column 404 so as to constrain the movement of the door 22 and fails to close the door 22.

After the adjustment of the position of the hooking member 418 to the door-fastened member 411 has finished, the door-fastened member 411 and the hooking member 418 are fixed with each other by a fastening member, such as a nut and a bolt, or by welding.

In this configuration example, the movable member 280 is provided in the column 404 (near the booth body 81), while the hooking member 418 is provided near the door 22. Conversely, the hooking member 418 may be provided in the column 404 (near the booth body 81), while the movable member 280 may be provided near the door 22.

In the above-described example, the position of the hooking portion (hooking member 418) is adjusted. Alternatively, the position of the movable member 280 may be adjusted, or both of the hooking member 418 and the movable member 280 may be adjusted.

The movable member 280 provided in the electric hook lock 281 may not necessarily be a turning movable member. The movable member 280 may be a linearly movable member, for example.

If a linearly movable member is used, the movable member 280 advances and retreats in a direction perpendicular to the moving direction of the door 22. When locking the door 22, the movable member 280 is inserted into a hole formed in the booth body 81 or the door 22 in the state in which the door 22 is closed. When unlocking the door 22, the movable member 280 retreats and moves back to the outside of the hole.

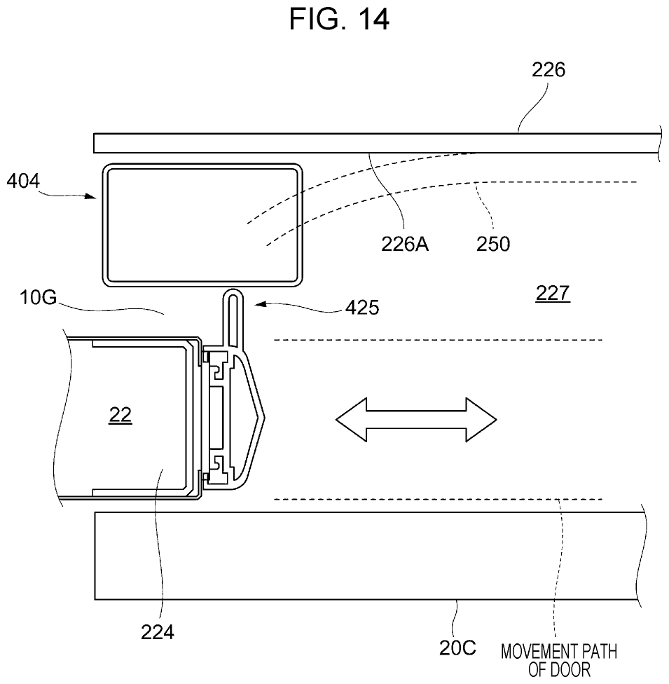

FIG. 14 is a sectional view of the booth 80 taken along line XIV-XIV in FIG. 2.

In the booth 80 taken along line XIV-XIV in FIG. 2, the electronic lock 22C is not shown in FIG. 14. The notch 404A formed in the column 404 in FIG. 12A is not shown, either, in FIG. 14.

Additionally, in the booth 80 taken along line XIV-XIV, the gap filling member 425 in FIG. 14 is longer than that in FIGS. 10A and 10B. In the state in which the door 22 is closed, the gap filling member 425 extends to the column 404 to fill the gap 10G between the column 404 and the elastic member 420, as shown in FIG. 14.

In the exemplary embodiment, the gap filling member 425 is constituted by a single component and is disposed along the second end portion 224 of the door 22 in the vertical direction.

The forward end of the portion of the gap filling member 425 which faces the constraining member 440 (see FIG. 12A) of the column 404 is cut short, as shown in FIGS. 10A and 10B. In contrast, the portion of the gap filling member 425 which does not face the constraining member 440 is elongated, as shown in FIG. 14.

Providing the gap filling member 425 in this manner makes it less likely to let sound and dust enter the booth 80 from the outside.

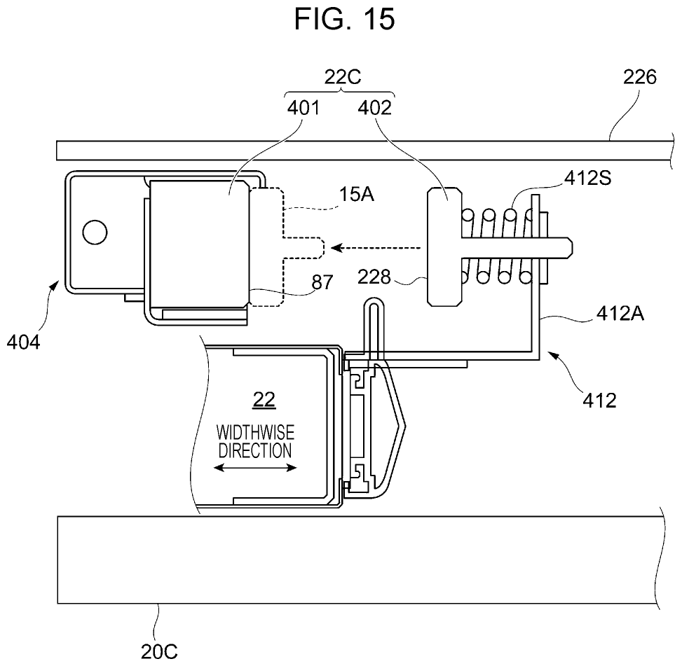

FIG. 15 is a sectional view illustrating another configuration example of the electronic lock 22C.

In this configuration example, a coil spring 412S, which is an example of an elastic body, is provided between the first part 412A of the support member 412 and the magnetic attraction object 402.

When a user closes the door 22 from the state in FIG. 15, the magnetic attraction object 402 is brought into contact with the electromagnet 401, as indicated by the dotted-line portion 15A in FIG. 15. When the user moves the door 22 to close it further, the coil spring 412S contracts to move the door 22 further and to bring the first end portion 223 (see FIG. 2) of the door 22 into contact with the side wall 20E.

In the configuration example in FIG. 15, while the door 22 is advancing in the widthwise direction to be closed, the door-side intersecting surface 228 of the magnetic attraction object 402 and the booth-side intersecting surface 87 of the electromagnet 401 contact each other. Even after this state, the door 22 advances further and is closed.

In this configuration example, the gap 11G shown in FIG. 11A is not formed between the first end portion 223 of the door 22 and the side wall 20E. This makes it possible to eliminate the provision of the projections 81E shown in FIG. 11A, the elastic body 80F shown in FIG. 11B, and the recessed portion 80G shown in FIG. 11C.

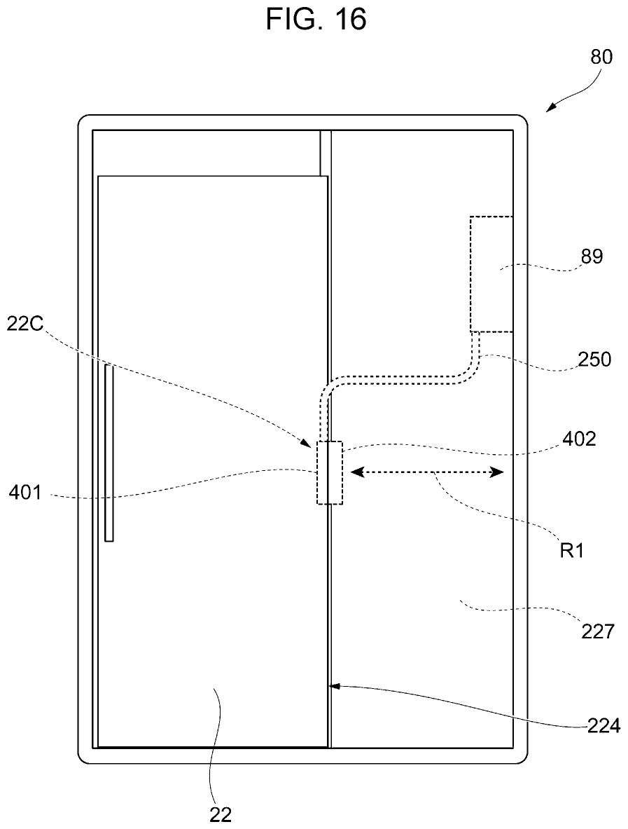

FIG. 16 illustrates an electrical wire 250 for feeding power to the electromagnet 401, as seen from the front side of the booth 80.

As shown in FIG. 16, the electrical wire 250 extends from the control device 89 to the electromagnet 401 to supply power to the electromagnet 401. In other words, the control device 89 controls the electronic lock 22C via the electrical wire 250.

The electrical wire 250 passes through the inside of the door box 227 (see FIG. 14) and extends to and connects to the electromagnet 401. In the exemplary embodiment, at least part of the electrical wire 250 passes through the inside of the door box 227. More specifically, the electrical wire 250 is fixed to an inner surface 226A (facing the side wall 20C) of the inner wall 226 (see FIG. 14) and is disposed along the inner surface 226A.

In the exemplary embodiment, the magnetic attraction object 402 (see FIG. 10B) is a portion to be secured to the booth body 81 by the electronic lock 22C.

When the door 22 is opened, this portion to be secured to the booth body 81 moves along a predetermined movement path R1 inside the door box 227, as shown in FIG. 16. To put it another way, the magnetic attraction object 402 moves along the movement path R1.

The electrical wire 250 passes through the inside of the door box 227 toward the electromagnet 401 while being out of the way of the movement path R1. More specifically, the electrical wire 250 passes above the movement path R1 toward the electromagnet 401.

The control device 89 is also disposed above the movement path R1. The electrical wire 250 passes above the movement path R1 from the control device 89 to the electromagnet 401.

In other words, the control device 89 is disposed above the movement path R1 and the electrical wire 250 is also disposed above the movement path R1.

When the door 22 is closed, the control device 89 is located closer to the door box 227 than to the second end portion 224 of the door 22. This arrangement enables the electrical wire 250 to pass through the door box 227 to extend from the control device 89 to the electronic lock 22C.

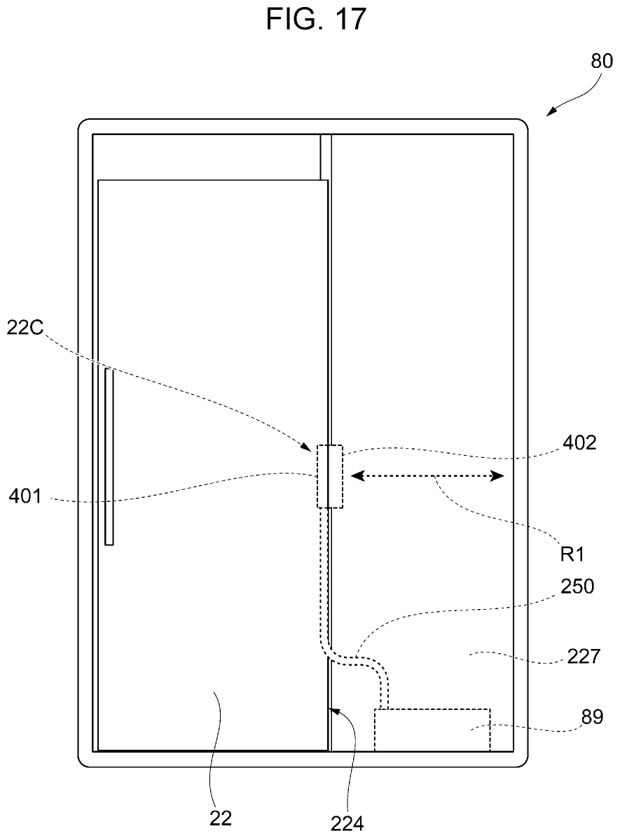

The control device 89 and the electrical wire 250 may be disposed in a different manner. For example, as shown in FIG. 17, the control device 89 may be disposed below the movement path R1 so that the electrical wire 250 can pass below the movement path R1 from the control device 89 to the electromagnet 401.

To put it another way, in the configuration example in FIG. 17, the control device 89 is disposed below the movement path R1 and the electrical wire 250 is also laid below the movement path R1.

In this configuration example, as well as in that in FIG. 16, when the door 22 is closed, the control device 89 is located closer to the door box 227 than to the second end portion 224 of the door 22. This enables the electrical wire 250 to pass through the door box 227 to extend from the control device 89 to the electronic lock 22C.

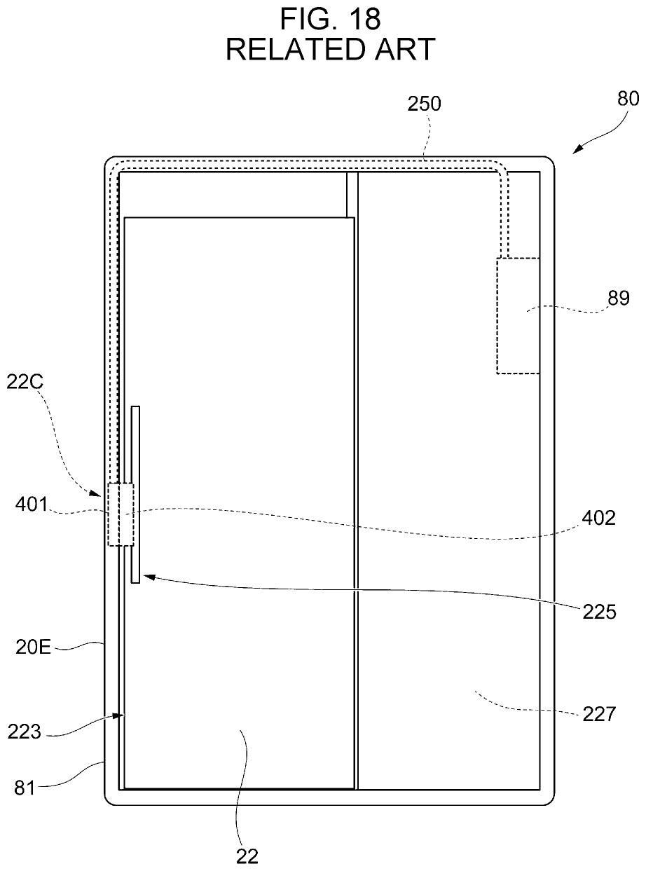

FIG. 18 illustrates a comparative example of the booth 80.

In this comparative example, the electronic lock 22C is provided in the first end portion 223 of the door 22. The first end portion 223 of the door 22 is secured to the booth body 81 by the electronic lock 22C.

More specifically, the electromagnet 401 is disposed on the side wall 20E, while the magnetic attraction object 402 is disposed on the first end portion 223 of the door 22.

The electrical wire 250 is also laid in this comparative example to extend from the control device 89 to the electromagnet 401.

In the comparative example, the electrical wire 250 passes through a portion other than the door box 227 to extend from the control device 89 to the electromagnet 401. Since the electrical wire 250 does not pass through the door box 227, it is required to be disposed in a narrow space.

More specifically, it is necessary that the electrical wire 250 pass through the inner side of a frame or a column forming the booth body 81 or the outer side of the booth body 81, which is time- and effort-consuming.

In the configuration in FIG. 18, the electronic lock 22C is disposed on the first end portion 223 of the door 22, which is close to the user-operable portion 225. The user-operable portion 225 is a portion to be touched by a user to open or close the door 22. When the user holds the user-operable portion 225, he/she may inadvertently touch the electromagnet 401 or the magnetic attraction object 402 forming the electronic lock 22C. This may cause a breakage or a fault of the electronic lock 22C, and the door 22 may not be locked or unlocked.

In contrast, in the exemplary embodiment, the electronic lock 22C is disposed in the second end portion 224 of the door 22, and a portion of the door 22 other than the first end portion 223 is secured to the booth body 81 by the electronic lock 22C. In this configuration, a user is less likely to touch the electronic lock 22C, thereby reducing the occurrence of a breakage or a fault of the electronic lock 22C.

In the exemplary embodiment, the electronic lock 22C is stored inside the door box 227, as shown in FIGS. 10A and 10B, which makes it even less likely for a user to touch the electronic lock 22C, thereby further reducing the occurrence of a breakage or a fault of the electronic lock 22C.

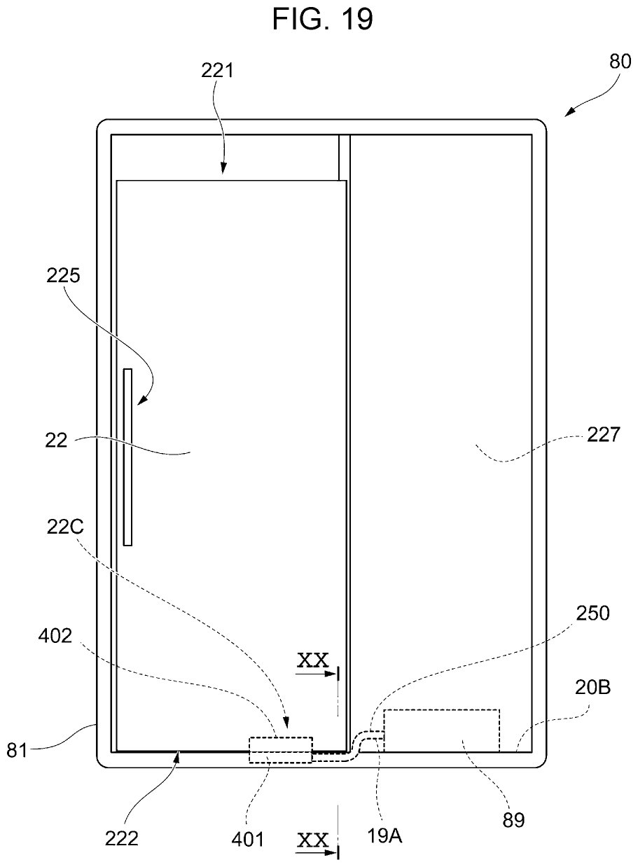

FIG. 19 illustrates another configuration example of the booth 80.

In this configuration example, the bottom end portion 222 of the door 22 is secured to the booth body 81 by the electronic lock 22C.

More specifically, the magnetic attraction object 402 is disposed in the bottom end portion 222 of the door 22, while the electromagnet 401 is disposed at a portion of the booth body 81 under the door 22.

The control device 89, which controls the electronic lock 22C, is disposed below the top end portion 221 of the door 22 and also below the user-operable portion 225 of the door 22.

The control device 89 is disposed on the floor 20B of the booth body 81, that is, at the bottom portion of the booth 80.

The electrical wire 250 extends from the control device 89, which is disposed at the bottom portion of the booth 80, to the electromagnet 401 also positioned at the bottom portion of the booth 80. A portion of the electrical wire 250 passes through the inside of the door box 227, as indicated by the dotted-line portion 19A.

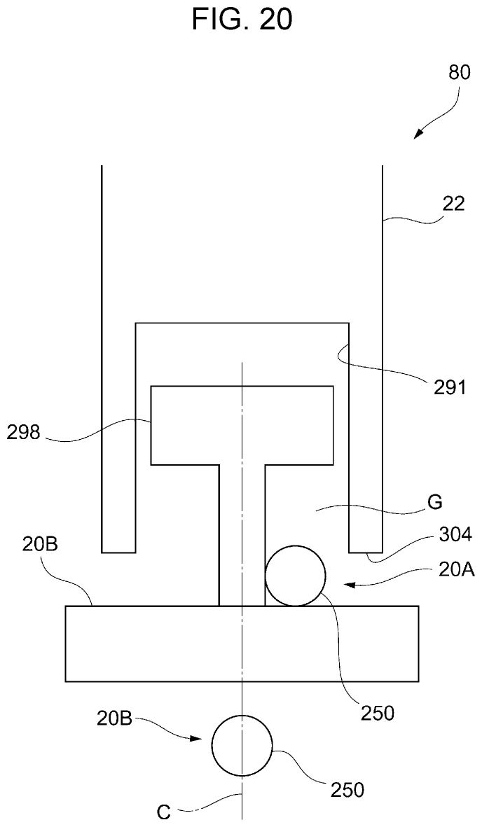

FIG. 20 is a sectional view of the booth 80 taken along line XX-XX in FIG. 19.

In the configuration example shown in FIGS. 19 and 20, a recessed portion 291 dented upward is formed in the bottom face 304 of the door 22. A rotator 298 is provided on the floor 20B of the booth body 81. The rotator 298 is supported by the floor 20B and rotates around a rotational axis C extending in the vertical direction. The rotator 298 enters the recessed portion 291 so as to guide the door 22.

A portion of the electrical wire 250 located under the door 22 passes through a gap G between the rotator 298 and the floor 20B, as indicated by reference numeral 20A in FIG. 20. The electrical wire 250 may be laid under the floor 20B, as indicated by reference numeral 20B in FIG. 20.

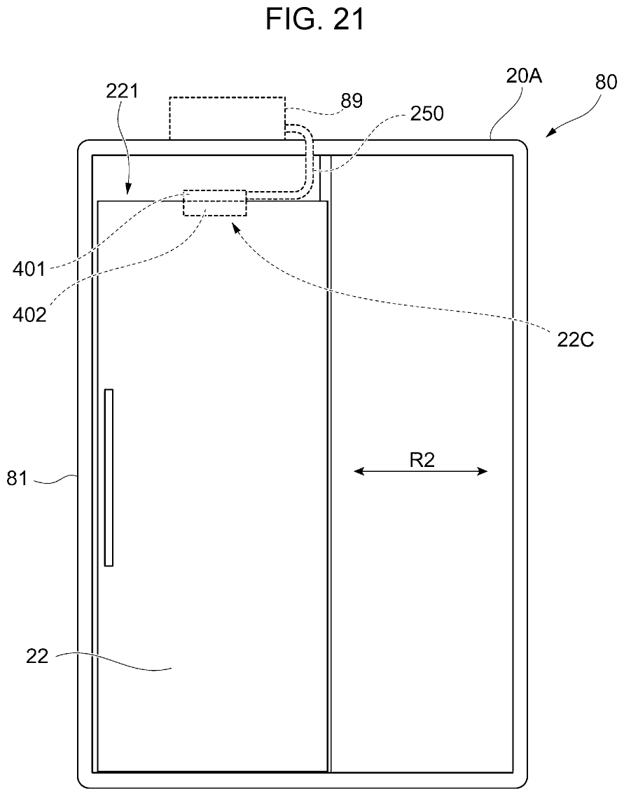

FIG. 21 illustrates another configuration example of the booth 80.

In this configuration example, the top end portion 221 of the door 22 is secured to the booth body 81 by the electronic lock 22C.

More specifically, the magnetic attraction object 402 is disposed in the top end portion 221 of the door 22, while the electromagnet 401 is disposed at a portion of the booth body 81 above the top end portion 221 of the door 22.

The control device 89, which controls the electronic lock 22C, is disposed above the top end portion 221 of the door 22, more specifically, on the ceiling 20A of the booth 80.

The electrical wire 250 extends from the control device 89 disposed above the top end portion 221 of the door 22 to the electromagnet 401 also positioned above the top end portion 221 of the door 22.

In this configuration example, the control device 89 is located above the top end portion 221 of the door 22. This makes it possible to avoid the interference between the moving path R2 of the door 22 and the electrical wire 250 extending from the control device 89 to the electromagnet 401.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A booth comprising:
a booth body;
a door that is openable and closable and that includes first and second end portions located at different positions in a widthwise direction of the door, a user-operable portion to be touched by a user to open and close the door being provided in the first end portion; and
a door lock that is used for locking the door, the door being locked under control of current supply to the door lock,
wherein a portion of the door other than the first end portion is secured to the booth body by the door lock.

2. The booth according to claim 1, wherein the second end portion of the door is secured to the booth body by the door lock.

3. The booth according to claim 1, wherein one of a bottom end portion and a top end portion of the door is secured to the booth body by the door lock.

4. The booth according to claim 1, wherein:
the door is a sliding door;
a door box is provided to store the door therein; and
the door lock is disposed inside the door box.

5. The booth according to claim 1, wherein:
the door lock includes an electromagnet and a magnetic attraction object, the electromagnet being disposed on or close to one of the door and the booth body, the magnetic attraction object being disposed on or close to the other one of the door and the booth body and being attracted to the electromagnet;
the electromagnet is disposed on or close to the booth body; and
the magnetic attraction object is disposed on or close to the door.

6. The booth according to claim 5, wherein a position of the magnetic attraction object in relation to the door is adjustable.

7. The booth according to claim 6, wherein:
the door is a sliding door and moves in the widthwise direction of the door; and
the position of the magnetic attraction object in relation to the door is adjustable in the widthwise direction.

8. The booth according to claim 1, wherein the door lock includes a movable member and a hooking portion, the movable member being disposed on or close to one of the door and the booth body and being hooked on the hooking portion, the hooking portion being disposed on or close to the other one of the door and the booth body.

9. The booth according to claim 8, wherein a position of at least one of the movable member and the hooking portion is adjustable.

10. The booth according to claim 8, wherein:
the door is a sliding door and moves in the widthwise direction of the door;
the movable member is disposed on or close to the booth body;
the hooking portion is disposed on or close to the door; and
a position of the hooking portion in relation to the door is adjustable in the widthwise direction.

11. The booth according to claim 1, wherein:
the door is a sliding door;
a door box is provided to store the door therein;
an electrical wire is disposed to extend to the door lock; and
at least part of the electrical wire passes through inside of the door box.

12. The booth according to claim 11, wherein:
when the door starts to open, a portion of the door to be secured to the booth body by the door lock moves along a predetermined path inside the door box; and
the electrical wire passes above or below the predetermined path inside the door box.

13. The booth according to claim 11, wherein:
when the door starts to open, the door moves inside the door box from the second end portion as a leading end;
the electrical wire extends from a control device to the door lock; and
in a state in which the door is closed, the control device is disposed closer to the door box than to the second end portion of the door.

14. The booth according to claim 1, wherein:
a control device is disposed to control the door lock;
when the door starts to open, a portion of the door to be secured to the booth body by the door lock moves along a predetermined path; and
the control device is disposed on one of an upper side above the predetermined path and a lower side below the predetermined path.

15. The booth according to claim 14, wherein:
an electrical wire is disposed to extend from the control device to the door lock; and
the control device is disposed on one of the upper side and the lower side, and the electrical wire is also disposed on the upper side or the lower side on which the control device is disposed.

16. The booth according to claim 1, wherein at least part of the door lock is stored inside a column disposed in the booth.

17. The booth according to claim 1, wherein:
the door is a sliding door and moves in the widthwise direction of the door;
a door-side intersecting surface is disposed on or close to the door to extend in a direction intersecting with the widthwise direction;
a booth-side intersecting surface is disposed on or close to the booth body to extend in a direction intersecting with the widthwise direction;
when the door is closed, the door-side intersecting surface and the booth-side intersecting surface face each other; and
one of the door-side intersecting surface and the booth-side intersecting surface is attracted to the other one of the door-side intersecting surface and the booth-side intersecting surface by the door lock so as to lock the door.

18. The booth according to claim 17, wherein, while the door is advancing in the widthwise direction to be closed, the door-side intersecting surface and the booth-side intersecting surface contact each other, and after the door-side intersecting surface and the booth-side intersecting surface contact each other, the door advances further and is closed.

19. The booth according to claim 1, wherein:
a top end portion of the door is secured to the booth body by the door lock; and
a control device that controls the door lock is disposed above the top end portion of the door.

20. The booth according to claim 1, wherein:
a bottom end portion of the door is secured to the booth body by the door lock; and
a control device that controls the door lock is disposed below a top end portion of the door.
